(19) United States
(12) Patent Application Publication
(10) Pub. No.: US 2023/0238188 A1
(43) Pub. Date: Jul. 27, 2023

(54) ELECTRODE MATERIAL INCLUDING BINARY METAL OXIDE, METHOD FOR PREPARING ELECTRODE INCLUDING THE SAME, AND SUPERCAPACITOR

(71) Applicant: National Taiwan University of Science and Technology, Taipei (TW)

(72) Inventors: Dong-Hau Kuo, Taipei (TW); Hardy Shuwanto, Taipei (TW); Siang-Jhih Jhuang, Taipei (TW); Hairus Abdullah, Taipei (TW)

(73) Assignee: National Taiwan University of Science and Technology, Taipei (TW)

(21) Appl. No.: 17/676,829

(22) Filed: Feb. 22, 2022

(30) Foreign Application Priority Data
Jan. 26, 2022 (TW) 111103311

(51) Int. Cl. H01G 11/46; H01G 11/86

(52) U.S. Cl. CPC H01G 11/46; H01G 11/86

(57) ABSTRACT

An electrode including a binary metal oxide, a method for preparing an electrode including the same, and a supercapacitor are provided. The binary metal oxide includes a first metal element and a second metal element. The first metal element includes a first transition metal element with two valence states. The second metal element is different from the first metal element and is selected from one of Mn, Fe, Ni, Zn, Al, Li, Ba, and La.

### CROSS-REFERENCE TO RELATED APPLICATION

This application claims the priority benefit of Taiwan application serial no. 111103311, filed on Jan. 26, 2022. The entirety of the above-mentioned patent application is hereby incorporated by reference herein and made a part of this specification.

### BACKGROUND OF THE INVENTION

### 1. Field of the Invention

The present invention relates to an electrode material for a supercapacitor, and more particular to an electrode material including a binary metal oxide, a method for preparing an electrode including the same, and a supercapacitor.

### 2. Description of Related Art

In recent years, the development of renewable energy has gradually received attention, and the electrochemical energy conversion is one of key factors in the renewable energy. Currently, lithium-ion batteries are widely used energy storage devices with charge-discharge functions in the industry. However, the lithium-ion batteries still have problems such as low specific capacitance and a low charge-discharge cycle life.

Generally, there are three types of electricity storage principle. The first type adopts a principle of electric double layer capacitors, which has a characteristic of fast charge-discharge, and since there is no chemical reaction during the energy storage process, it also has the characteristic of long cycle life. However, the first type usually faces a problem of low energy density. The second type adopts a principle of pseudo-capacitors, which electrode thereof may perform a diffusion-type redox reaction to enhance the energy density and the specific capacitance. However, the stability of the electrode would decrease. The third type adopts a hybrid principle of combining the first type and the second type to obtain an optimal energy storage effect. However, the energy density and the specific capacitance of the supercapacitor are still lower than those of ordinary lithium-ion batteries, which limits their application to short-term backup energy devices and cannot expand their application fields.

### SUMMARY OF THE INVENTION

The present invention provides an electrode material including a binary metal oxide, a method for preparing an electrode including the same, and a supercapacitor including the same, in which the binary metal oxide is designed to include a first metal element including a first transition metal element with two valance states and a second metal element selected from one of Mn, Fe, Ni, Zn, Al, Li, Ba, and La to allow the electrode material having good performance. For example, the electrode material may have good performance in specific capacitor, energy density, and/or power density.

An embodiment of the present invention provides an electrode material including a binary metal oxide. The binary metal oxide includes a first metal element and a second metal element different from the first metal element. The first metal element includes a first transition metal element with two valance states. The second metal element is selected from Mn, Fe, Ni, Zn, Al, Li, Ba, and La.

In the embodiment of the present invention, the content of the first metal element is greater than the content of the second metal element.

In the embodiment of the present invention, the second metal element is selected from a second transition metal element with three valance states, and the second transition metal element is different from the first transition metal element.

In the embodiment of the present invention, the first transition metal element is Co, and the second transition metal element is Mn.

In the embodiment of the present invention, mole ratio of the first transition metal element to the second transition metal element ranges from about 5:1 to about 1:5.

In the embodiment of the present invention, the mole ratio of the first transition metal element to the second transition metal element ranges from about 5:1 to about 1:1.

In the embodiment of the present invention, the mole ratio of the first transition metal element to the second transition metal element is about 2:1.

An embodiment of the present invention provides a method for preparing an electrode including a binary metal oxide. The method includes following steps: mixing a first precursor containing a first metal element and a second precursor containing a second metal element to form a precursor solution, wherein the first metal element includes a first transition metal element with two valence states, and the second metal element is different from the first metal element and selected from one of Mn, Fe, Ni, Zn, Al, Li, Ba, and La; adding a reaction auxiliary agent to the precursor solution to form a reaction solution; and placing a conductive electrode-supporting material to the reaction solution and forming a binary metal oxide on the conductive electrode-supporting material by a hydrothermal process.

In the embodiment of the present invention, the molar ratio of the precursor solution to the reaction auxiliary agent ranges from about 1:9 to about 1:33.

In the embodiment of the present invention, the reaction auxiliary agents include a urea and an ammonium fluoride (NH₄F), and the molar ratio of the urea and the ammonium fluoride ranges from about 5:2 to about 5:20.

In the embodiment of the present invention, the content of the first precursor is greater than the content of the second precursor.

In the embodiment of the present invention, the second metal element is selected from a second transition metal element with three valence states, and the second transition metal element is different from the first transition metal element.

In the embodiment of the present invention, the first transition metal element is Co, and the second transition metal element is Mn.

In the embodiment of the present invention, the molar ratio of the first precursor to the second precursor is about 2:1.

In the embodiment of the present invention, the method further includes performing an annealing process to the binary metal oxide after forming the binary metal oxide on the conductive electrode-supporting material.

An embodiment of the present invention provides a supercapacitor including a positive electrode, a negative electrode, a separator, and an electrolyte. The positive electrode includes the electrode material including the binary metal oxide as described above. The negative electrode is disposed opposite to the positive electrode. The separator is disposed between the positive electrode and the negative electrode, wherein the positive electrode and the negative electrode are disposed at opposite sides of the separator. The electrolyte is disposed between the positive electrode and the negative electrode and filling a space between the positive electrode and the separator and a space between the negative electrode and the separator.

In the embodiment of the present invention, the negative electrode includes an active carbon or the electrode material including the binary metal oxide as described above.

In the embodiment of the present invention, the electrolyte includes an alkaline electrolyte in liquid state or a gel-state electrolyte.

In the embodiment of the present invention, the alkaline electrolyte includes KOH, NaOH, or LiOH.

In the embodiment of the present invention, the concentration of the alkaline electrolyte is equal to or larger than 1 M.

Based on the above, in the above electrode material including the binary metal oxide, the method for preparing the electrode including the same, and the supercapacitor including the same, the binary metal oxide is designed to include a first metal element including a first transition metal element with two valance states and a second metal element selected from one of Mn, Fe, Ni, Zn, Al, Li, Ba, and La to allow the electrode material having good performance. For example, the electrode material may have good performance in specific capacitor, energy density, and/or power density.

To make the above features and advantages of the disclosure more comprehensible, several embodiments accompanied with drawings are described in detail as follows.

### BRIEF DESCRIPTION OF THE DRAWINGS

FIG. 1 is a schematic diagram of a supercapacitor.

FIG. 2 is the X-ray photoelectron spectroscopy (XPS) diagram for 2p orbitals of cobalt and manganese.

FIG. 3 is a schematic diagram illustrating a charge-discharge curve of the supercapacitor in which the alkaline electrolyte is KOH, NaOH and LiOH, respectively.

FIG. 4 is a schematic diagram illustrating a charge-discharge curve of the supercapacitor at different concentrations in which the alkaline electrolyte is KOH.

FIG. 5 is a schematic diagram related to the change of the specific capacitance of the supercapacitor during several charge-discharge cyclic processes.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The invention will be described more comprehensively below with reference to the drawings for the embodiments. However, the invention may also be implemented in different forms rather than being limited by the embodiments described in the invention. Thicknesses of layer and region in the drawings are enlarged for clarity. The same reference numbers are used in the drawings and the description to indicate the same or like parts, which are not repeated in the following embodiments.

It will be understood that when an element is referred to as being “on” or “connected” to another element, it may be directly on or connected to the other element or intervening elements may be present. If an element is referred to as being “directly on” or “directly connected” to another element, there are no intervening elements present. As used herein, “connection” may refer to both physical and/or electrical connections, and “electrical connection” or “coupling” may refer to the presence of other elements between two elements. As used herein, “electrical connection” may refer to the concept including a physical connection (e.g., wired connection) and a physical disconnection (e.g., wireless connection).

As used herein, “about”, “approximately” or “substantially” includes the values as mentioned and the average values within the range of acceptable deviations that can be determined by those of ordinary skill in the art. Consider to the specific amount of errors related to the measurements (i.e., the limitations of the measurement system), the meaning of “about” may be, for example, referred to a value within one or more standard deviations of the value, or within ±30%, ±20%, ±10%, ±5%. Furthermore, the “about”, “approximate” or “substantially” used herein may be based on the optical property, etching property or other properties to select a more acceptable deviation range or standard deviation, but may not apply one standard deviation to all properties.

The terms used herein are used to merely describe exemplary embodiments and are not used to limit the present disclosure. In this case, unless indicated in the context specifically, otherwise the singular forms include the plural forms.

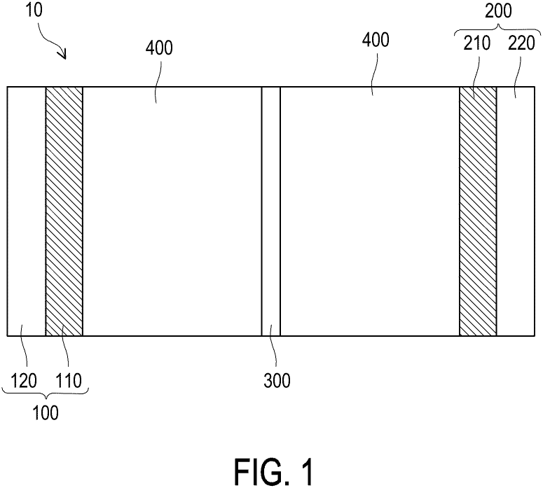

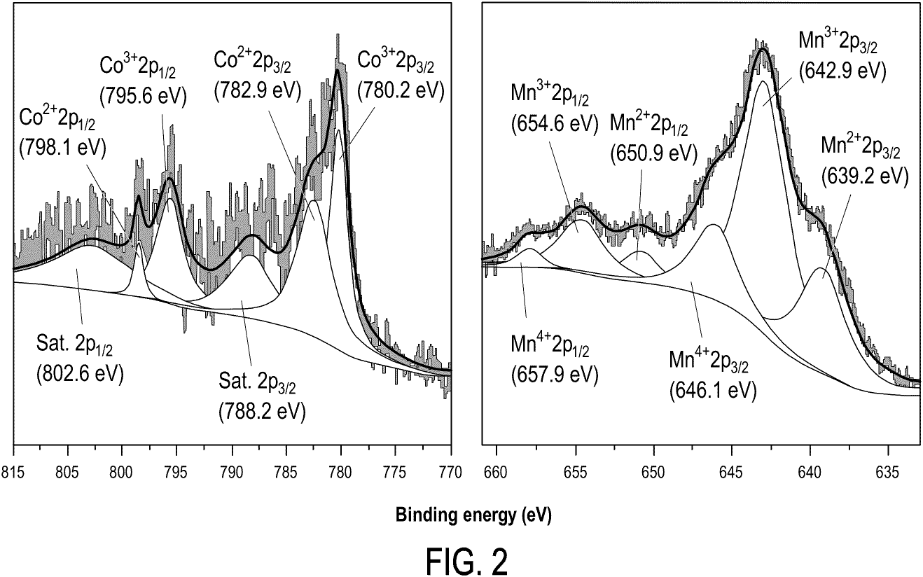

FIG. 1 is a schematic diagram of a supercapacitor. FIG. 2 is the X-ray photoelectron spectroscopy (XPS) diagram for 2p orbitals of cobalt and manganese.

Referring to FIG. 1, a supercapacitor 10 may include a positive electrode 100, a negative electrode 200, a separator 300, and an electrolyte 400.

The positive electrode 100 may include an electrode material 110 including a binary metal oxide and a collector 120. The collector 120 may include a conductive electrode-supporting material. In some embodiments, the conductive electrode-supporting material may include a porous Ni foam. The binary metal oxide may include a first metal element and a second metal element. The first metal element may include a first transition metal element with two valance states. The second metal element may be different from the first metal element and selected from one of Mn, Fe, Ni, Zn, Al, Li, Ba, and La. In the case where the positive electrode 100 of the supercapacitor 10 includes the electrode material 110 including the binary metal oxide as described above, the supercapacitor 10 may have good performance in specific capacitor, energy density, and/or power density.

In some embodiments, the content of the first metal element may be larger than the content of the second metal element. In some embodiments, the second metal element may be selected from the second transition metal element with three valance states, and the second transition metal element is different from the first transition metal element. For example, the first transition metal element may be Co, and the second transition metal element may be Mn. As shown in FIG. 2, Co has two valance states (e.g., Co²⁺ and Co³⁺) and Mn has three valance states (e.g., Mn²⁺, Mn³⁺ and Mn⁴⁺).

In some embodiments, the molar ratio of the first transition metal element to the second transition metal element may range from about 5:1 to about 1:5. When the molar ratio of the first transition metal element to the second transition metal element is within the above range, the supercapacitor 10 may have good performance in specific capacitor, energy density, and/or power density. In some other embodiments, the molar ratio of the first transition metal element to the second transition metal element may range from about 5:1 to about 1:1. In some alternative embodiments, the molar ratio of the first transition metal element to the second transition metal element is about 2:1.

In some embodiments, the electrode material 110, for example, may be prepared by following steps. Firstly, a first precursor containing a first metal element and a second precursor containing a second metal element are mixed to form a precursor solution, wherein the first metal element may include the first transition metal element with two valance states, and the second metal element may be different from the first metal element and selected from one of Mn, Fe, Ni, Zn, Al, Li, Ba, and La. Then, a reaction auxiliary agent is added to the precursor solution to form a reaction solution. After that, a conductive electrode-supporting material is placed in the reaction solution and then the binary metal oxide is formed on the conductive electrode-supporting material through a hydrothermal process. In some embodiments, the hydrothermal process may be performed at 120° C. for 6 hours.

In some embodiments, the content of the first precursor may be greater than the content of the second precursor. In some embodiments, the second metal element may be selected from the second transition metal element with three valance states. In some embodiments, the first transition metal element may be Co, and the second transition metal element may be Mn. In some embodiments, the molar ratio of the first precursor to the second precursor may range from about 5:1 to about 1:5. When the molar ratio of the first transition metal element to the second transition metal element is within the above range, the supercapacitor 10 may have good performance in specific capacitor, energy density, and/or power density. In some other embodiments, the molar ratio of the first transition metal element to the second transition metal element may range from about 5:1 to about 1:1. In some alternative embodiments, the molar ratio of the first transition metal element to the second transition metal element may be about 2:1.

In some embodiments, the molar ration of the precursor solution to the reaction auxiliary agent may range from about 1:9 to about 1:33. In some embodiments, the reaction auxiliary agents may include a urea and an ammonium fluoride (NH₄F). In some embodiments, the molar ratio of the urea to the ammonium fluoride may range from about 5:2 to about 5:20.

In some embodiments, a cleaning process may be performed on the electrode including the binary metal oxide and being subjected to the hydrothermal process. For example, the cleaning process is performed on the electrode including the binary metal oxide and being subjected to the hydrothermal process by using a deionized water and an ethanol. In some embodiments, the cleaned electrode may be dried at 60° C. for 1 hour after performing the above cleaning process. In some embodiments, an annealing process may be performed on the dried electrode. In some embodiments, the annealing process may be conducted at 400° C. for 2 hours, for example.

The negative electrode 200 may be disposed opposite to the positive electrode 100. In some embodiments, the negative electrode 200 may include an electrode material 210 and a collector 220. The electrode material may include an active carbon or the binary metal oxide as described above. In the case where the electrode material 110 and the electrode material 210 are made of different materials (e.g., the electrode material 110 of the positive electrode 100 includes the binary metal oxide; and the electrode material 210 of the negative electrode 200 includes the active carbon), the supercapacitor 10 may be deemed to have an asymmetric structure. In the case where the electrode material 110 and the electrode material 210 are made of the same material (e.g., both the electrode material 110 of the positive electrode 100 and the electrode material 210 of the negative electrode 200 include the binary metal oxide), the supercapacitor 10 may be deemed to have a symmetric structure. The collector 220 may include a conductive electrode-supporting material. In some embodiments, the conductive electrode-supporting material may include a porous Ni foam.

The separator 300 may be disposed between the positive electrode 100 and the negative electrode 200, such that the positive electrode 100 and the negative electrode 200 are disposed at opposite sides of the separator 300. The separator 300 may have, for example, fine holes to allow the electrolyte 400 passing through. The material of the separator 300 may include, for example, polyethylene, polypropylene, or a combination thereof.

The electrolyte 400 may be disposed between the positive electrode 100 and the negative electrode 200 and filling a space between the positive electrode 100 and the separator 300 and a space between the negative electrode 200 and the separator 300. In some embodiments, the electrolyte may include an alkaline electrolyte in liquid state. For example, the electrolyte 400 may include the alkaline electrolyte in liquid state such as KOH, NaOH, or LiOH. In some embodiments, the concentration of the alkaline electrolyte in liquid state may be equal to or larger than 1 M (e.g., 1 M to 12 M).

Features of the disclosure will be described more specifically below with reference to Examples and Comparative Examples. Although the following Examples are described, the used materials, their quantities and ratios, processing details, processing flow, and the like may be appropriately changed without departing from the scope of the disclosure. Therefore, the disclosure should not be interpreted restrictively by Examples described below.

### Preparation of Examples 1-1 to 1-8

### Example 1-1

Firstly, a precursor containing Co and a precursor containing Mn were dissolved in a reactive autoclave lined with Teflon in a molar ratio of 2:1 to form a precursor solution. Next, a reaction auxiliary agent including a urea and an ammonium fluoride was added to the above precursor solution, wherein the molar ratio of the precursor solution to the reaction auxiliary agent is about 1:20. Then, a porous Ni foam, which was cleaned beforehand, was placed in the reactive autoclave and then a hydrothermal process is performed at 120° C. for 6 hours to obtain an electrode including a binary metal oxide. After that, the electrode was cleaned with the deionized water and the ethanol and was dried at 60° C. for 1 hour. Then, an annealing process was performed on the cleaned electrode at 400° C. for 2 hours to complete the preparation of Example 1-1.

### Example 1-2

An electrode including a binary metal oxide of Example 1-2 was prepared in the same manner as in Example 1-1 except that the precursor containing Fe was used instead of the precursor containing Mn.

### Example 1-3

An electrode including a binary metal oxide of Example 1-3 was prepared in the same manner as in Example 1-1 except that the precursor containing Ni was used instead of the precursor containing Mn.

### Example 1-4

An electrode including a binary metal oxide of Example 1-4 was prepared in the same manner as in Example 1-1 except that the precursor containing Zn was used instead of the precursor containing Mn.

### Example 1-5

An electrode including a binary metal oxide of Example 1-5 was prepared in the same manner as in Example 1-1 except that the precursor containing Al was used instead of the precursor containing Mn.

### Example 1-6

An electrode including a binary metal oxide of Example 1-6 was prepared in the same manner as in Example 1-1 except that the precursor containing Li was used instead of the precursor containing Mn.

### Example 1-7

An electrode including a binary metal oxide of Example 1-7 was prepared in the same manner as in Example 1-1 except that the precursor containing Ba was used instead of the precursor containing Mn.

### Example 1-8

An electrode including a binary metal oxide of Example 1-8 was prepared in the same manner as in Example 1-1 except that the precursor containing La was used instead of the precursor containing Mn.

### Preparation of Comparative Examples 1-1 to 1-3

### Comparative Example 1-1

An electrode including a binary metal oxide of Comparative Example 1-1 was prepared in the same manner as in Example 1-1 except that the precursor containing Cu was used instead of the precursor containing Mn.

### Comparative Example 1-2

An electrode including a binary metal oxide of Comparative Example 1-2 was prepared in the same manner as in Example 1-1 except that the precursor containing V was used instead of the precursor containing Mn.

### Comparative Example 1-3

An electrode including a binary metal oxide of Comparative Example 1-3 was prepared in the same manner as in Example 1-1 except that the precursor containing Y was used instead of the precursor containing Mn.

### Preparation of Examples 2-1 to 2-5

### Example 2-1

An electrode including a binary metal oxide of Example 2-1 was prepared in the same manner as in Example 1-1 except that the molar ratio of the precursor containing Co to the precursor containing Mn was about 5:1 instead of about 2:1.

### Example 2-2

An electrode including a binary metal oxide of Example 2-2 was prepared in the same manner as in Example 2-1 except that the molar ratio of the precursor containing Co to the precursor containing Mn was about 2:1 instead of about 5:1.

### Example 2-3

An electrode including a binary metal oxide of Example 2-3 was prepared in the same manner as in Example 2-1 except that the molar ratio of the precursor containing Co to the precursor containing Mn was about 1:1 instead of about 5:1.

### Example 2-4

An electrode including a binary metal oxide of Example 2-4 was prepared in the same manner as in Example 2-1 except that the molar ratio of the precursor containing Co to the precursor containing Mn was about 1:2 instead of about 5:1.

### Example 2-5

An electrode including a binary metal oxide of Example 2-5 was prepared in the same manner as in Example 2-1 except that the molar ratio of the precursor containing Co to the precursor containing Mn was about 1:5 instead of about 5:1.

### Preparation of Comparative Examples 2-1 to 2-2

### Comparative Example 2-1

An electrode including a binary metal oxide of Comparative Example 2-1 was prepared in the same manner as in Example 1-1 except that only the precursor containing Mn was dissolved in the reactive autoclave.

### Comparative Example 2-2

An electrode including a binary metal oxide of Comparative Example 2-2 was prepared in the same manner as in Example 1-1 except that only the precursor containing Co was dissolved in the reactive autoclave.

### Experiment 1

The electrodes of Examples 1-1 to 1-8 and Comparative Examples 1-1 to 1-3 were used as the positive electrode of the supercapacitor, the specific capacitance value, energy density and power density of the half-cell of the supercapacitor were measured at a current density of 1 A/g, and the results are shown in Table 1 below.

TABLE 1

| | Specific capacitance value (F/g) | Energy density (Wh/kg) | Power density (W/kg) |
|---|---|---|---|
| Comparative Example 1-1 | 160 | 2 | 150 |
| Comparative Example 1-2 | 18 | 1 | 250 |
| Comparative Example 1-3 | 67 | 1 | 150 |
| Example 1-1 | 7249 | 305 | 275 |
| Example 1-2 | 440 | 10 | 200 |
| Example 1-3 | 690 | 9 | 150 |
| Example 1-4 | 2135 | 125 | 325 |
| Example 1-5 | 1660 | 21 | 150 |
| Example 1-6 | 2457 | 31 | 150 |
| Example 1-7 | 3605 | 93 | 215 |
| Example 1-8 | 2297 | 135 | 325 |

From Table 1, in the case where the electrodes of Examples 1-1 to 1-8 were used as the positive electrode of the supercapacitor, the supercapacitor may have good performance in specific capacitor, energy density, and power density as compared to the case where the electrodes of Comparative Examples 1-1 to 1-3 were used as the positive electrodes of the supercapacitor.

### Experiment 2

The electrodes of Examples 2-1 to 2-5 and Comparative Examples 2-1 and 2-2 were used as the positive electrode of the supercapacitor, the specific capacitance value, energy density and power density of the half-cell of the supercapacitor were measured at a current density of 1 A/g, and the results are shown in Table 2 below.

TABLE 2

| | Voltage difference (V) | Time difference (s) | Specific capacitance value (F/g) | Energy density (Wh/kg) | Power density (W/kg) |
|---|---|---|---|---|---|
| Comparative Example 2-1 | 0.55 | 557 | 1013 | 43 | 275 |
| Comparative Example 2-2 | 0.55 | 383 | 696 | 29 | 275 |
| Example 2-1 | 0.55 | 2884 | 5244 | 220 | 275 |
| Example 2-2 | 0.55 | 3893 | 7078 | 297 | 275 |
| Example 2-3 | 0.55 | 1837 | 3340 | 140 | 275 |
| Example 2-4 | 0.55 | 1552 | 2822 | 119 | 275 |
| Example 2-5 | 0.55 | 1132 | 2058 | 86 | 275 |

From Table 2, the supercapacitors, in which the electrodes of Examples 2-1 to 2-5 were used as the positive electrode, may have good performance as compared to the supercapacitors in which the electrodes of Comparative Examples 2-1 to 2-2 were used as the positive electrodes.

### Experiment 3

The electrodes of Examples 2-1 to 2-5 and Comparative Examples 2-1 and 2-2 were used as the negative electrode of the supercapacitor, the specific capacitance value, energy density and power density of the half-cell of the supercapacitor were measured at a current density of 1 A/g, and the results are shown in Table 3 below.

TABLE 3

| | Voltage difference (V) | Time difference (s) | Specific capacitance value (F/g) | Energy density (Wh/kg) | Power density (W/kg) |
|---|---|---|---|---|---|
| Comparative Example 2-1 | 0.4 | 128 | 320 | 7 | 200 |
| Comparative Example 2-2 | 0.4 | 155 | 388 | 9 | 200 |
| Example 2-1 | 0.4 | 528 | 1320 | 29 | 200 |
| Example 2-2 | 0.4 | 1045 | 2613 | 58 | 200 |
| Example 2-3 | 0.4 | 712 | 1780 | 40 | 200 |
| Example 2-4 | 0.4 | 675 | 1688 | 38 | 200 |
| Example 2-5 | 0.4 | 452 | 1130 | 25 | 200 |

From Table 3, the supercapacitors in which the electrodes of Examples 2-1 to 2-5 were used as the negative electrodes may have good performance as compared to the supercapacitors in which the electrodes of Comparative Examples 2-1 to 2-2 were used as the negative electrodes.

### Experiment 4

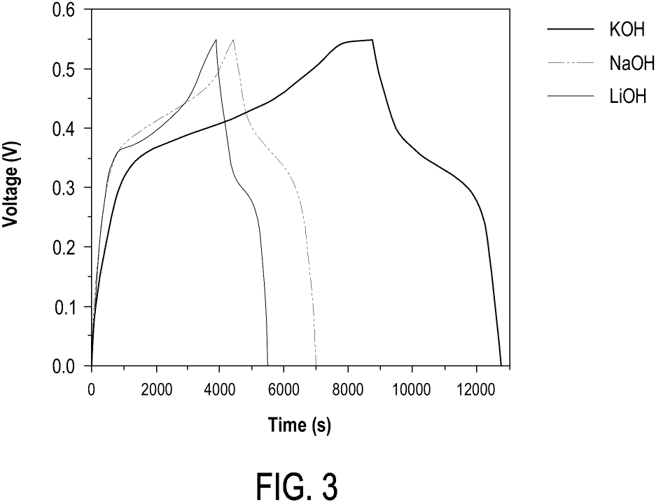

The electrode of Example 1-1 was used as the positive electrode of the supercapacitor, and the liquid alkaline electrolytes listed in Table 4 below were used as the electrolyte of the supercapacitor. The specific capacitance value, energy density and power density of the half-cell of the supercapacitor were measured at a current density of 1 A/g, and the results are shown in FIG. 3 and arranged in Table 4 below. FIG. 3 is a schematic diagram illustrating a charge-discharge curve of the supercapacitor in which the alkaline electrolyte is KOH, NaOH and LiOH, respectively.

TABLE 4

| Electrolyte | Voltage difference (V) | Time difference (s) | Specific capacitance value (F/g) | Energy density (Wh/kg) | Power density (W/kg) |
|---|---|---|---|---|---|
| KOH | 0.55 | 3987 | 7249 | 305 | 275 |
| NaOH | 0.55 | 2631 | 4784 | 201 | 275 |
| LiOH | 0.55 | 1630 | 2964 | 125 | 275 |

From FIG. 3 and Table 4, in the case where the alkaline electrolytes in liquid state were used as the electrolyte of the supercapacitor, the supercapacitor may have good performance in specific capacitor, energy density, and power density.

### Experiment 5

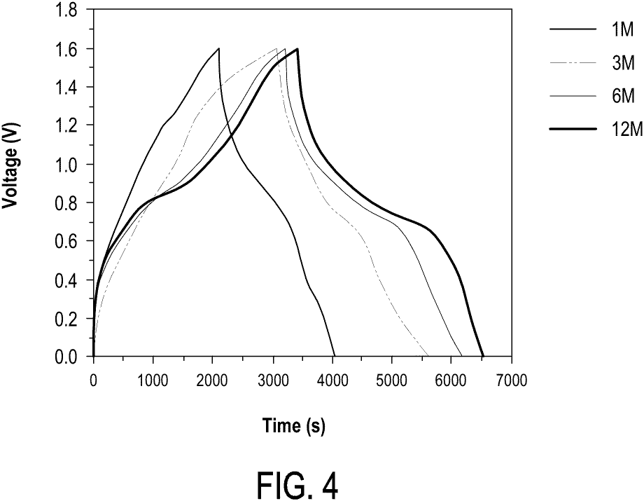

The electrode of Example 1-1 was used as the positive and negative electrodes of the supercapacitor, and KOH with different concentrations that lists in Table 4 below were used as the electrolyte of the supercapacitor. The specific capacitance value, energy density and power density of the full-cell of the supercapacitor were measured at a current density of 1 A/g, and the results are shown in FIG. 4 and arranged in Table 5 below. FIG. 4 is a schematic diagram illustrating a charge-discharge curve of the supercapacitor at different concentrations in which the alkaline electrolyte is KOH.

TABLE 5

| Concentration of KOH (M) | Voltage difference (V) | Time difference (s) | Specific capacitance value (F/g) | Energy density (Wh/kg) | Power density (W/kg) |
|---|---|---|---|---|---|
| 1 | 1.6 | 1987 | 1242 | 442 | 800 |
| 3 | 1.6 | 2987 | 1867 | 664 | 800 |
| 6 | 1.6 | 3184 | 1990 | 708 | 800 |
| 12 | 1.6 | 2826 | 1766 | 628 | 800 |

From FIG. 4 and Table 5, the specific capacitor and the energy density of the supercapacitor reached the maximum value when the concentration of KOH was 6 M. However, when the concentration of KOH was equal to or larger than 3 M, the increase in the specific capacitor and energy density of the supercapacitor began to slow down.

### Preparation of Examples 3-1 to 3-4 and Comparative Example 3

### < Examples 3-1 to 3-4 and Comparative Example 3>

Electrodes including binary metal oxides of Examples 3-1, 3-2, and 3-4 and Comparative Example 3 were prepared in the same manner as in Example 1-1 except that the ratio of the precursor solution to the reaction auxiliary agent that lists in Table 6 below were used instead of the ratio about 1: 20. An electrode including a binary metal oxide of Example 3-3 was one of Embodiments that was prepared in the same manner as in Example 1-1.

TABLE 6

| | Comparative Example 3 | Example 3-1 | Example 3-2 | Example 3-3 | Example 3-4 |
|---|---|---|---|---|---|
| Co(NO₃)₂ (mmol) | 0.5 | 0.5 | 0.5 | 0.5 | 0.5 |
| Mn(NO₃)₂ (mmol) | 0.25 | 0.25 | 0.25 | 0.25 | 0.25 |
| Urea (mmol) | 5 | 5 | 5 | 5 | 5 |
| Ammonium fluoride (mmol) | 0 | 2 | 5 | 10 | 20 |
| Ratio (precursor solution/ reaction auxiliary agent) | 0.15 | 0.11 | 0.075 | 0.05 | 0.03 |

### Experiment 6

The electrodes of Examples 3-1 to 3-4 and Comparative Example 3 were used as the positive electrodes of the supercapacitor, the specific capacitance value, energy density and power density of the half-cell of the supercapacitor were measured at a current density of 1 A/g, and the results are shown in Table 7 below.

TABLE 7

| | Voltage difference (V) | Time difference (s) | Specific capacitance value (F/g) | Energy density (Wh/kg) | Power density (W/kg) |
|---|---|---|---|---|---|
| Comparative Example 3 | 0.55 | 978 | 1778 | 75 | 275 |
| Example 3-1 | 0.55 | 2534 | 4607 | 194 | 275 |
| Example 3-2 | 0.55 | 2837 | 5158 | 217 | 275 |
| Example 3-3 | 0.55 | 3987 | 7249 | 305 | 275 |
| Example 3-4 | 0.55 | 3624 | 6589 | 277 | 275 |

From Table 7, the supercapacitors, in which the electrodes of Examples 3-1 to 3-4 were used as the positive electrode, may have good performance in specific capacitor, energy density, and power density.

### Experiment 7

An asymmetric supercapacitor was prepared by using the electrode of Example 1-1 as the positive electrode and using the active carbon as the negative electrode. In addition, 3 M KOH was used as the liquid alkaline electrolyte of the supercapacitor. The specific capacitance value, energy density and power density of the full-cell of the asymmetric supercapacitor were measured at current densities of 1 A/g, 2 A/g, 5 A/g, 10 A/g, 30 A/g and 50 A/g, respectively, and the results are shown in FIG. 8 below.

TABLE 8

| Current density (A/g) | Voltage difference (V) | Time difference (s) | Specific capacitance value (F/g) | Energy density (Wh/kg) | Power density (W/kg) |
|---|---|---|---|---|---|
| 1 | 1.6 | 774 | 484 | 172 | 800 |
| 2 | 1.6 | 151 | 189 | 67 | 1600 |
| 5 | 1.6 | 43 | 134 | 48 | 4000 |
| 10 | 1.6 | 15 | 94 | 33 | 8000 |
| 30 | 1.6 | 2.5 | 47 | 17 | 24000 |
| 50 | 1.6 | 1.3 | 41 | 14 | 40000 |

From Table 8, the asymmetric supercapacitor has good performance in specific capacitor, energy density, and power density.

### Experiment 8

A symmetric supercapacitor was prepared by using the electrodes of Example 1-1 as both the positive and negative electrodes and using 3 M KOH as the liquid alkaline electrolyte. The specific capacitance value, energy density and power density of the full-cell of the symmetric supercapacitor were measured at current densities of 1 A/g, 2 A/g, 5 A/g, 10 A/g, 30 A/g and 50 A/g, respectively, and the results are shown in FIG. 9 below.

TABLE 9

| Current density (A/g) | Specific capacitance value (F/g) | Energy density (Wh/kg) | Power density (W/kg) |
|---|---|---|---|
| 1 | 1867 | 664 | 800 |
| 2 | 1974 | 702 | 1600 |
| 5 | 1894 | 673 | 4000 |
| 10 | 1394 | 496 | 8000 |
| 30 | 1331 | 473 | 24000 |
| 50 | 1125 | 400 | 40000 |

From Table 9, the symmetric supercapacitor has good performance in specific capacitor, energy density, and power density.

### Experiment 9

A symmetric supercapacitor was prepared by using the electrodes of Example 1-1 as both the positive and negative electrodes and using KOH-PVA in gel-state as the electrolyte. The specific capacitance value, energy density and power density of the full-cell of the symmetric supercapacitor were measured at current densities of 1 A/g, 2 A/g, 5 A/g, 10 A/g, 30 A/g and 50 A/g, respectively, and the results are shown in FIG. 10 below.

TABLE 10

| Current density (A/g) | Specific capacitance value (F/g) | Energy density (Wh/kg) | Power density (W/kg) |
|---|---|---|---|
| 1 | 960 | 341 | 800 |
| 2 | 613 | 218 | 1600 |
| 5 | 475 | 169 | 4000 |
| 10 | 363 | 129 | 8000 |
| 30 | 206 | 73 | 24000 |
| 50 | 119 | 42 | 40000 |

From Table 10, the symmetric supercapacitor in which the gel-state KOH-PVA was used as the electrolyte has good performance in specific capacitor, energy density, and power density. Referring to Table 9 and Table 10, the supercapacitor in which the liquid KOH was used as the liquid alkaline electrolyte has better performance in specific capacitor, energy density, and power density as compared to the the supercapacitor in which the gel-state KOH-PVA was used as the electrolyte.

### Experiment 10

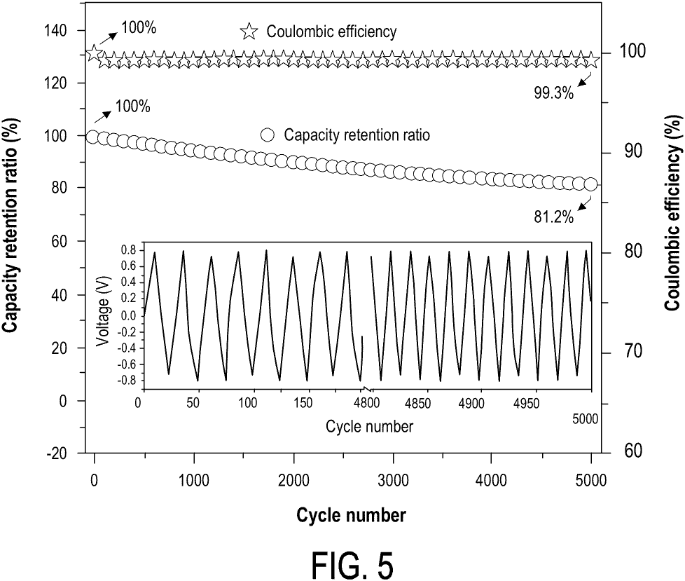

A symmetric supercapacitor was prepared by using the electrodes of Example 1-1 as both the positive and negative electrodes and using 3 M KOH as the liquid alkaline electrolyte. The symmetric supercapacitor was tested for 5000 cycles of rapid charge and discharge at a high current density of 50A/g, and the results are shown in FIG. 5. FIG. 5 is a schematic diagram related to the change of the specific capacitance of the supercapacitor during several charge-discharge processes.

Referring to FIG. 5, the capacity retention ratio and the coulombic efficiency of the symmetric supercapacitor were 81.2% and 99.3 %, respectively, after being tested for 5000 cycles of rapid charge and discharge. From here, the symmetric supercapacitor is deemed to have a characteristic of high cycle life.

Based on the above, in the above embodiments related to the electrode material including the binary metal oxide, the method for preparing the electrode including the same, and the supercapacitor including the same, the binary metal oxide is designed to include a first metal element including a first transition metal element with two valance states and a second metal element selected from one of Mn, Fe, Ni, Zn, Al, Li, Ba, and La to allow the electrode material having good performance. For example, the electrode material may have good performance in specific capacitor, energy density, and/or power density.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An electrode material comprising a binary metal oxide, wherein the binary metal oxide comprises:
a first metal element comprising a first transition metal element with two valence states; and
a second metal element being different from the first metal element and selected from one of Mn, Fe, Ni, Zn, Al, Li, Ba, and La.

2. The electrode material of claim 1, wherein the content of the first metal element is greater than the content of the second metal element.

3. The electrode material of claim 1, wherein the second metal element is selected from a second transition metal element with three valence states, and the second transition metal element is different from the first transition metal element.

4. The electrode material of claim 3, wherein the first transition metal element is Co, and the second transition metal element is Mn.

5. The electrode material of claim 4, wherein the mole ratio of the first transition metal element to the second transition metal element ranges from about 5:1 to about 1:5.

6. The electrode material of claim 4, wherein the mole ratio of the first transition metal element to the second transition metal element ranges from about 5:1 to about 1:1.

7. The electrode material of claim 4, wherein the mole ratio of the first transition metal element to the second transition metal element is about 2:1.

8. A method for preparing an electrode comprising a binary metal oxide, comprising:
mixing a first precursor containing a first metal element and a second precursor containing a second metal element to form a precursor solution, wherein the first metal element comprises a first transition metal element with two valence states, and the second metal element is different from the first metal element and selected from one of Mn, Fe, Ni, Zn, Al, Li, Ba, and La;
adding a reaction auxiliary agent to the precursor solution to form a reaction solution; and
placing a conductive electrode-supporting material to the reaction solution and forming a binary metal oxide on the conductive electrode-supporting material by a hydrothermal process.

9. The method of claim 8, wherein the molar ratio of the precursor solution to the reaction auxiliary agent ranges from about 1:9 to about 1:33.

10. The method of claim 8, wherein the reaction auxiliary agents comprise a urea and an ammonium fluoride (NH₄F), and the molar ratio of the urea and the ammonium fluoride ranges from about 5:2 to about 5:20.

11. The method of claim 8, wherein the content of the first precursor is greater than the content of the second precursor.

12. The method of claim 8, wherein the second metal element is selected from a second transition metal element with three valence states, and the second transition metal element is different from the first transition metal element.

13. The method of claim 12, wherein the first transition metal element is Co, and the second transition metal element is Mn.

14. The method of claim 13, wherein the molar ratio of the first precursor to the second precursor is about 2:1.

15. The method of claim 8, further comprising:
performing an annealing process to the binary metal oxide after forming the binary metal oxide on the conductive electrode-supporting material.

16. A supercapacitor, comprising:
a positive electrode comprising an electrode material comprising a binary metal oxide, wherein the binary metal oxide comprises:
a first metal element comprising a first transition metal element with two valence states; and
a second metal element being different from the first metal element and selected from one of Mn, Fe, Ni, Zn, Al, Li, Ba, and La;
a negative electrode disposed opposite to the positive electrode;
a separator disposed between the positive electrode and the negative electrode, wherein the positive electrode and the negative electrode are disposed at opposite sides of the separator; and
an electrolyte disposed between the positive electrode and the negative electrode and filling a space between the positive electrode and the separator and a space between the negative electrode and the separator.

17. The supercapacitor of claim 16, wherein the negative electrode comprises an active carbon or the electrode material comprising the binary metal oxide.

18. The supercapacitor of claim 16, wherein the electrolyte comprises an alkaline electrolyte in liquid state or a gel-state electrolyte.

19. The supercapacitor of claim 18, wherein the alkaline electrolyte comprises KOH, NaOH, or LiOH.

20. The supercapacitor of claim 19, wherein the concentration of the alkaline electrolyte is equal to or larger than 1 M.
